(19) United States
(12) Patent Application Publication
(10) Pub. No.: US 2015/0379487 A1
(43) Pub. Date: Dec. 31, 2015

(54) SYSTEM AND METHOD TO FACILITATE THE EXCHANGE OF PAYMENT INFORMATION

(71) Applicant: PaymentWorks LLC, Cambridge, MA (US)

(72) Inventors: Seth Thayer Stewart, New Caaan, CT (US); Alan Wayne Greenblatt, Sudbury, MA (US)

(73) Assignee: PAYMENTWORKS LLC, Cambridge, MA (US)

(21) Appl. No.: 14/315,278

(22) Filed: Jun. 25, 2014

(51) Int. Cl. G06Q 20/10; G06Q 30/04

(52) U.S. Cl. CPC G06Q 20/102; G06Q 30/04

(57) ABSTRACT

A system and related method configured to facilitate the exchange of important payment information between Payers (Accounts Payable Departments) and Payees (the Accounts Receivable and Collections Departments of their suppliers). The system requires users to enter particular information about payers and payees and further requires payees to produce specific information in order to establish a secure connection with a payer. The type of information to be exchanged includes but is not limited to invoice numbers, prior purchase orders and internal stains codes.

### BACKGROUND OF THE INVENTION

1. Field of the Invention

The present invention is a software-as-a-service (“SaaS”) application embodied in a system and a method. The Invention facilitates the exchange of important payment information between Payers (Accounts Payable Detriments) and Payees (the Accounts Receivable and Collections Departments of their suppliers). More particularly the present invention enables Payers to “connect” with Payees in order to exchange private information in a secure fashion.

2. Description of the Prior Art

There are a number of “supplier networks” that enable companies and their suppliers to exchange information electronically. Before companies can start exchanging information electronically on these networks, the network providers must establish a relationship with the supplier's organization (company name, address, Tax ID number, etc.) and their customer's internal “vendor code”. A vendor code is a unique number that a company maintains in its internal accounting system to identify that supplier. In every company, there is a new “vendor set-up process,” which creates a unique record for each supplier. The record is identified with a vendor code, and usually contains such things as the supplier's name, address, Tax Payer ID number, etc. Going forward, that supplier is identified by their unique vendor code in that company's internal system.

Today, all of the supplier networks use a similar process to establish the vendor code assignment. They take the supplier's internal vendor code and match it with a unique “credential” (a system generated number or hyperlink), which is provided to that supplier (via email or traditional mail) when they enroll in the service to “connect” with that particular customer. This enables the supplier network provider to create a relationship between that supplier's “account” (unique login) and the customer's “account” (unique login) to enable secure exchange of information between the two business entities on the network.

### SUMMARY OF THE INVENTION

The present invention is a novel way of connecting suppliers to their customer, eliminating the need to use pre-assigned credentials. The invention includes a system and a method (also retorted to herein as a process) for the secure exchange of information between suppliers (also referred to herein as payees) and their customers (also referred to herein as payers). The system is embodied at least in part in a computing device and a database, wherein steps associated with operation of the system are embodied in one or more computer programs, for secure exchange of information between payers and payees. The system includes a function configured to upload a master payee vendor file containing vendor information to a database of an information exchange system, a function configured to upload invoice status information to the database, a function configured to generate an invitation from a payer to a payee to join the information exchange system and to configure prompts that the payee will be required to enter to make a connection, a function configured to prompt the payee to enter the prompts information when they attempt to make a connection, a function configured to derive a specific vendor code for the payee based upon the prompts information that the payee enters and a function configured to establish a connection, between the payee and the payer in order for them to exchange private information regarding one or more business interactions between the payer and the payee. The information provided by the payee may be validated automatically by the system based on previously installed information from a reliable source. Alternatively, the payee information may be validated manually or otherwise independently by the payer. Therefore, a payee may be approved automatically by the system or manually or otherwise by the payer.

The method or process includes the steps of uploading a master payee vendor like containing vendor information to a database of an information exchange system, uploading invoice status information to the database, generating an invitation from a payer to a payee to join the information exchange system, enabling the payer to configure prompts that the payee is required to enter to make a connection, prompting the payee to enter the prompts information when they attempt to make a connection, deriving a specific vendor code for the payee based upon the prompts information the payee enters and establishing a connection between the payee and the payer in order for them to exchange private information regarding one or more business interactions between the payer and the payee.

The advantages of the present invention will become apparent upon review of the following detailed description, the accompanying drawings and the appended claims.

### BRIEF DESCRIPTION OF THE DRAWINGS

FIG. 1 is a display of a first screen representing the initial interface for a user to access the system of the present invention through the Upload Data tab.

FIG. 2 is a display of a second screen representing an interface for a user to access the system of the present invention to establish payee criteria to permit a secure exchange with a payer through the Set Connection Rules tab.

FIG. 3 is a display of a third screen representing an interface for a user to access the system of the present invention to access the relational database of payers that may be engaged by a payee through the Connection tab.

FIG. 4 is a display of a fourth screen representing an interface for a payee user to access the relational database and determine connection information required by a payer through the Connection tab.

FIG. 5 is a display of a filth screen representing an interface for a user representing the establishment of a connection between a payer and a payee after passing through the steps identified after clicking on the Connection tab.

FIG. 6 is a first simplified diagram representing the flow of information for customer and supplier subscription to the system of the present invention.

FIG. 7 is a second simplified diagram representing the flow of information for customers to invite their suppliers to engage in the system of the present invention.

FIG. 8 is a third simplified diagram representing the flow of information for suppliers to establish an account and engage with customers through the system of the present invention.

FIG. 9 is a fourth simplified diagram representing the flow of information for customers to obtain vendor codes for suppliers to complete an exchange of payment in accordance with the function of the present invention.

FIG. 10 is a simplified representation of a computing system suitable for carrying out the functions of the present invention as described herein.

### DETAILED DESCRIPTION OF THE INVENTION

The present invention is a system and process arranged to facilitate the exchange of information and/or services over the Internet. More particularly, the present invention is a system and process for improving the mechanism by which customers and suppliers exchange information and facilitate supplier payment. The present invention is referred to herein from time to time as PaymentWorks, which is a trademark of the owner of the invention.

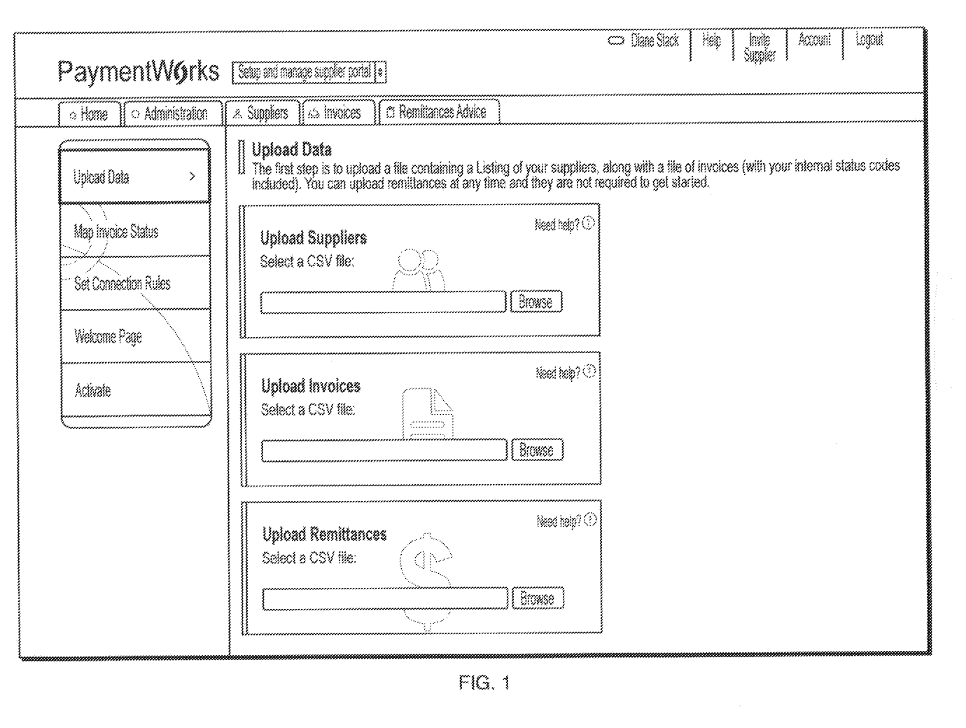

With reference to FIG. 1, a first step in the process enables users that may be characterized as customers or “Payers” to sign up tor the services provided through the present invention. In particular, the first step in the process is for the Payers, who may also be identified as Accounts Payable departments, to upload relevant information to the PaymentWorks site. There are two types of information that are required:
1) Payee (or “supplier”) Information
a. Supplier name
b. Internal vendor code
e. Street, City, State, Zip
d. Tax payer ID number (if available)
2) Invoice Status Information
a. Internal vendor code
b. Invoice number, amount, date
c. Internal status code (has the invoice been approved, paid, etc.)
d. Purchase order number
e. Scheduled payment date
f Check number (or ACM number) if paid.

There are three ways that Payers can provide this information. First, Payers can upload files using a suitable format, such as CSV or Excel, for example, which files contain the above information, by going to the PaymentWorks Internet website, locating the file in their local directory, and manually uploading it to the site. Second, Payers can send files, containing this information, directly from their Accounts Payable system to the PaymentWorks site, using a secure protocol such as FTPS (File Transfer Protocol over Secure Sockets Layer/SSL). Third, the PaymentWorks website has a set of published “APIs” (application programming interfaces), which the Payer can use to push data from their accounts payable system, using real-time system calls over a secure protocol such as HTTPS (Hypertext Transfer Protocol over SSL).

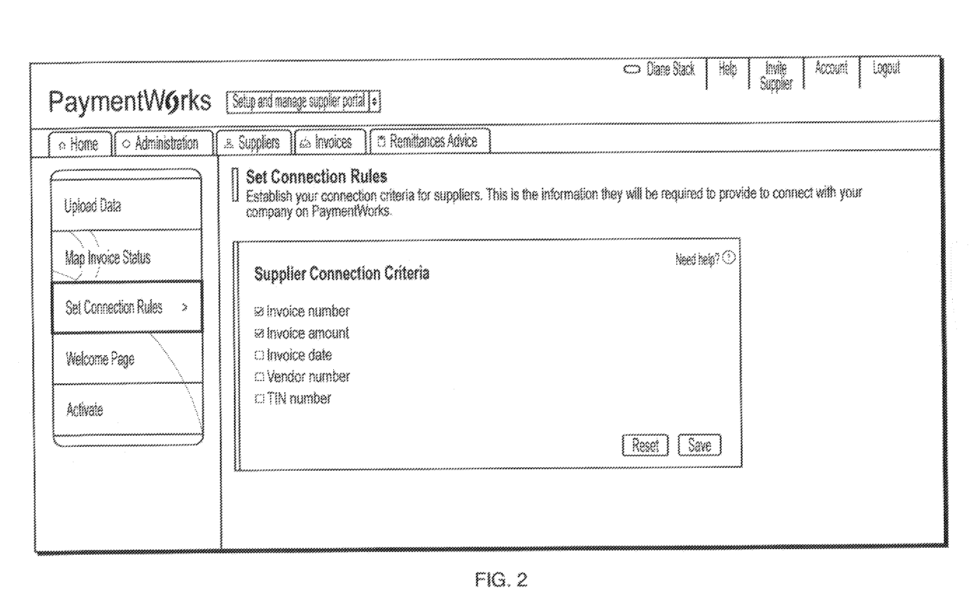

With reference to FIG. 2, the next step in the process is that the Payer determines what information its suppliers or service providers (identified from time to time herein as “Payees”) must enter in order for Payment Works to: 1) Derive the internal vendor code for that particular Payee, and 2) Ensure the authenticity of the Payee. These are Set Connection Rules, which may he defined by the Payer, with some, all or no guidance from the system. Examples of the types of information to be provided include, but are not limited to:
a. A recent invoke (number, date, amount) submitted to that Payer/customer over the past three months
b. A recent purchase order (number, date, amount) issued to them by that Payer/customer over the past three months
c. A recent check payment (number, date, amount) that has been issued to them by that Payer/customer in the last three months
d. The supplier's Tax Payer ID number
e. The supplier's Vendor Code, which has been assigned to them by that customer.

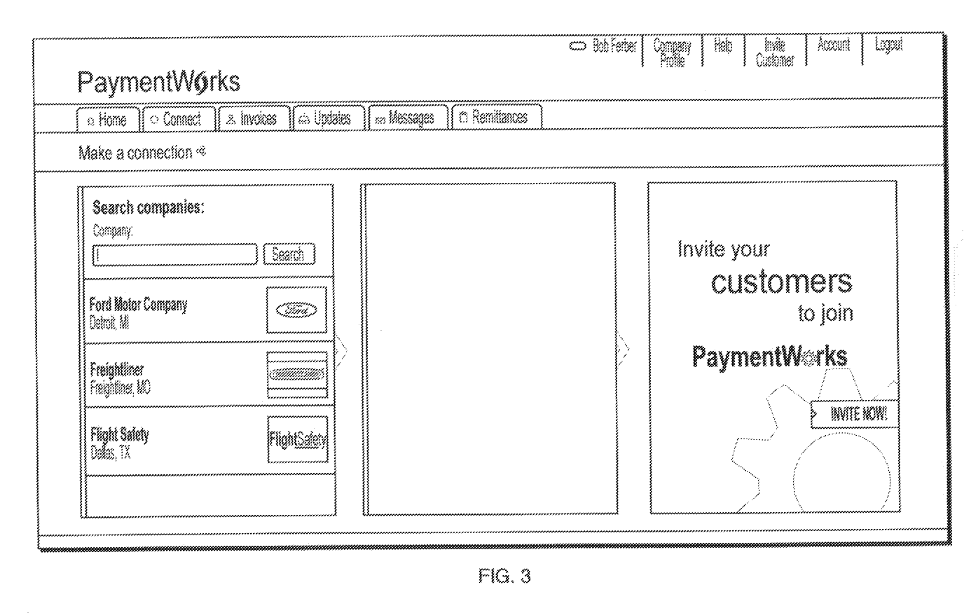

With reference to FIG. 3, in order to connect with the Payer, Payees go to the PaymentWorks website (www.paymentworks.com), and look up their corporate customers (“Payers”) in a directory by typing their corporate name (e.g. Ford Motor Company) and clicking on their name.

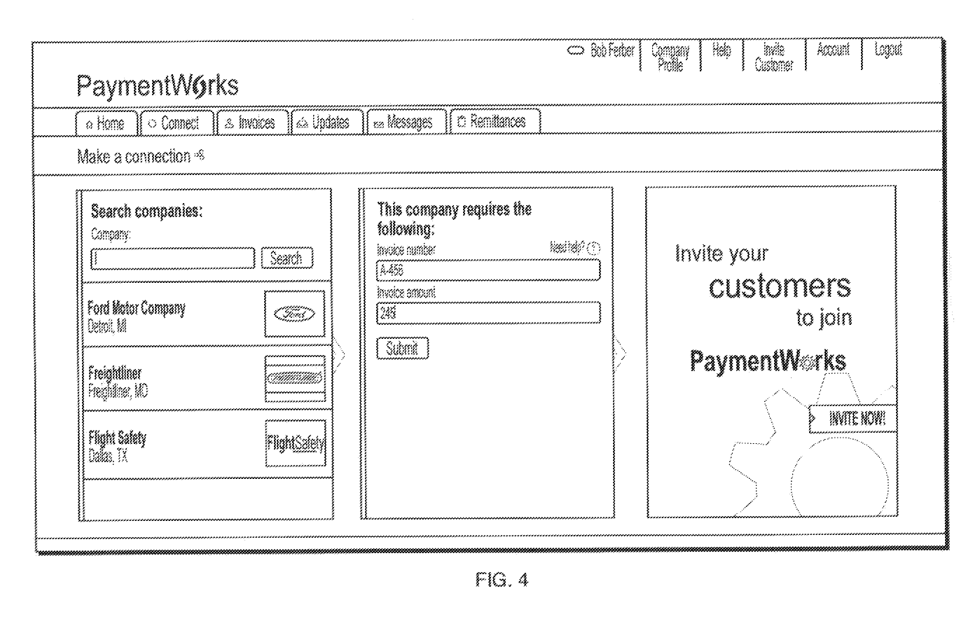

With reference to FIG. 4, the system of the present invention then prompts them to enter information, which only they would know. The specific information that is required is determined by the Payer (See Set Connection Rules above). Examples of the types of information (however, this is not an exhaustive list) are:
a. A recent invoice (number, date, and amount) submitted to that customer over the past three mouths
b. A recent purchase order (number, date, and amount) issued to them by that customer over the past three mouths
c. A recent check payment (number, date, amount) that has been made to them in the last three months
d. The supplier's Tax Payer ID number
e. The supplier's Vendor Code, which has been assigned to them by that customer
f. Some combination of the above.

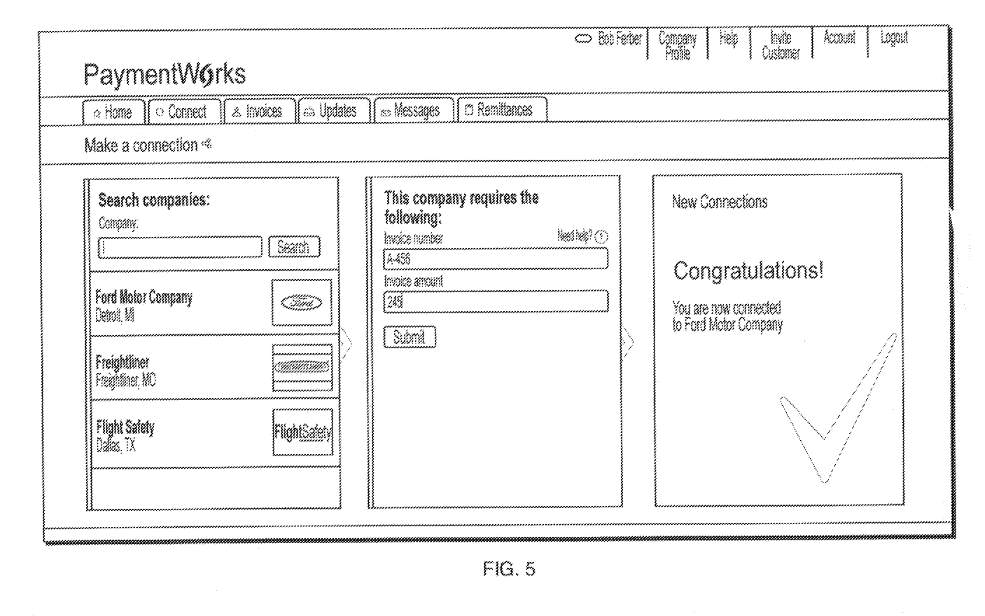

With reference to FIG. 5, if the Payee enters the Information correctly, the system derives the internal vendor code that the customer uses to identify that particular Payee and ensures the authenticity of the Payee such as by authentication processes known to those skilled in the art of website access security. Once they are connected to the Payer, a Payee can exchange information back and forth with that Payer. For instance, they can view the status of invoices that they have submitted to the Payer, send messages, and update their bank account information so their customers can pay them electronically.

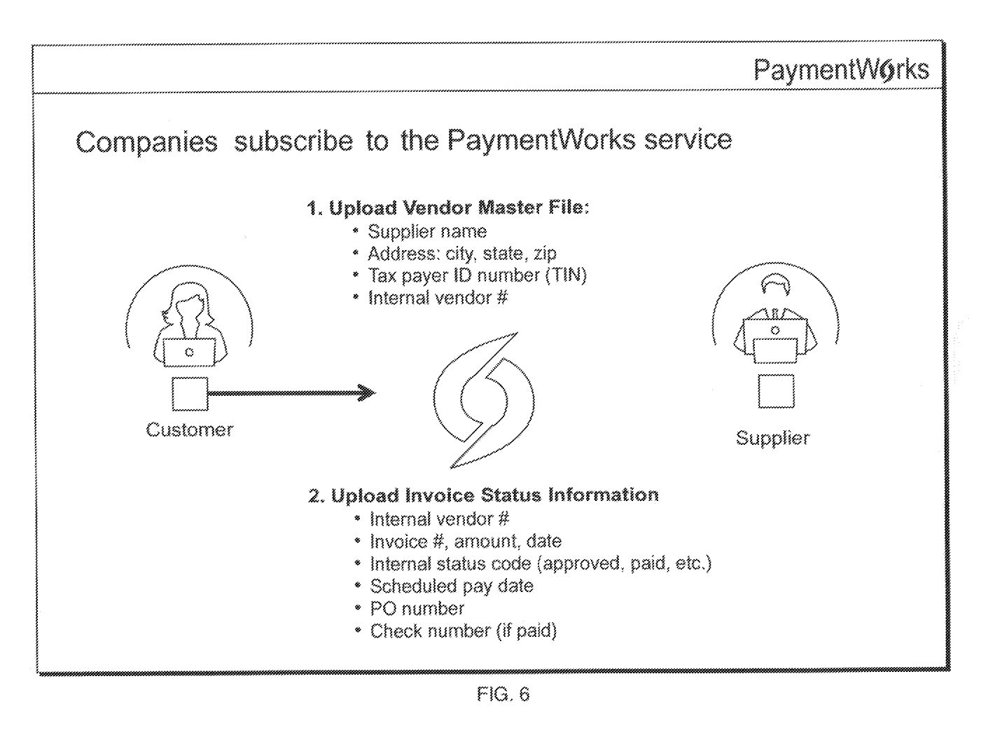

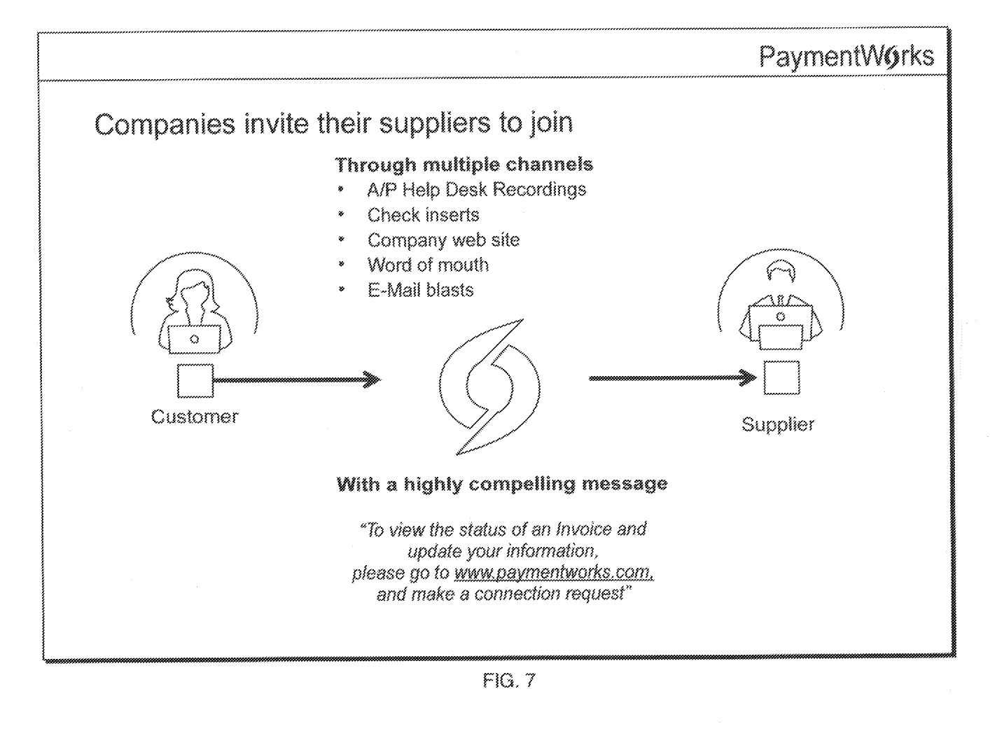

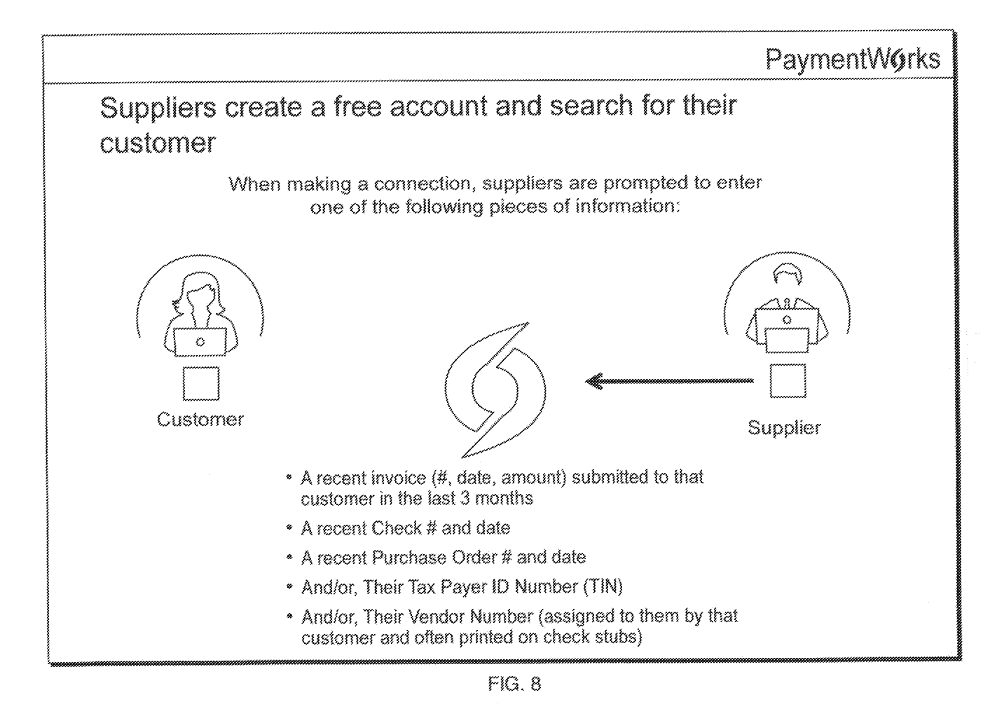

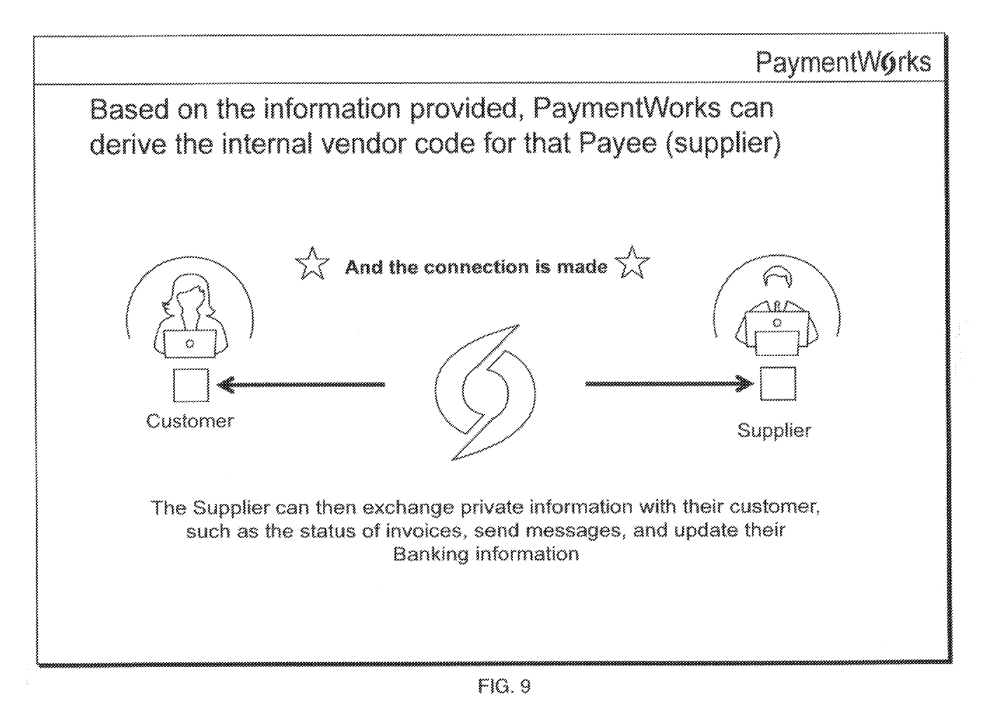

The remaining tabs shown on FIGS. 1-5 represent links to invoices, messages, payment information and the like that may be accessed upon completion of a secure connection. The type of information that may be exchanged or accessed is not limited to that described by the tabs represented therein. FIGS. 6-9 provide representations of the detailed steps associated with the process described herein for linking a Payer and a Payee together in a secure and simple manner.

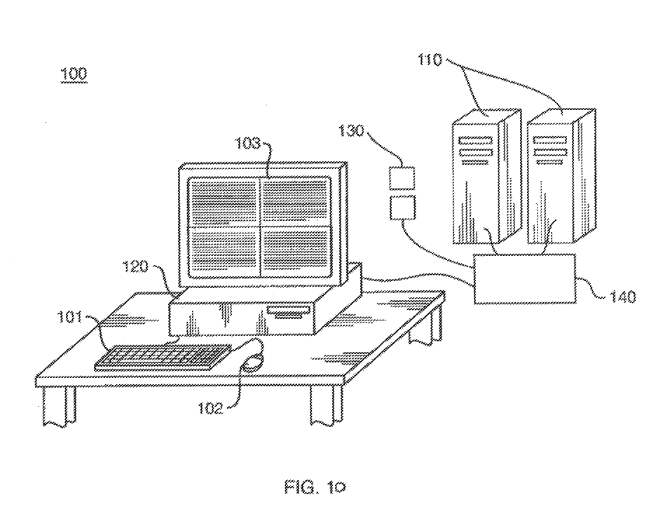

The present invention is a system, process and related database for gathering and storing Payer and Payee information to enable access to that information and to enable manipulation of that information to produce payment information and, if desired, payment instructions. The system and database are embodied in a computing system programmed to perform functional steps associated with the storing of the information for the purpose of accessing it and carrying out actions based on it. Any type of computing system suitable to store information in the amount of interest and to perform calculations of interest on the information may be employed and is represented generally in FIG. 10. The computer system 100 shown is only one example of a suitable computing environment and is not intended to suggest any limitation as to the scope of use or functionality of the invention. For example, the computer system 100 may be associated with local or remote computing means, such as one or more central computers, such as server 110 in a local area network, a metropolitan area network, a wide area network, or through intranet and internet connections.

The computer system 100 may include one or more discrete computer processor devices, represented, by desktop computer 120, for example. Examples of well known computing devices that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. The computer system 100 may include computer devices operated by one or more users, such as through a desktop, laptop, mobile devices such as smart phones, or servers, and/or one or more providers of services corresponding to one or more functions of the invention.

The server 110, the computer processor 120, or a combination of both may be programmed to include one or more of the functions of the invention system. The relational database of the present invention for gathering, storing and making accessible the Payer and Payee information, is represented by Database 130. For the purpose of the description of the present invention, a database is a collection of stored data that are logically related. Although there are different types of databases, and the Database 130 of the present invention may be any of such types, it is preferably a relational database with a relational database management system, comprising tables made up of rows and columns. Date stored in the relational tables are accessed or updated using database queries submitted to the database system.

Database 130 may be associated with the server 110, the computer processor 120, other computing devices, or any combination thereof, includes information related to the use of the invention system. The Database 130 may be associated with a single computing device or a plurality of devices. The Database 130 may be centrally located or it may be distributed locally or widely. The Database 130 is populated and updated with the information of the typo previously described in a format suitable for access and manipulation as is known to those skilled in the art of database management. All of the devices may be interconnected through one or more signal exchange devices, such as router/switch 140.

The invention may be described in the general context of computer-executable instructions, such as program modules, being executed by a computer such as the computer system 100. Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processor 120 and interactive drives, memory storage devices, databases, including but not limited to the Database 130, and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system 100 typically includes a variety of computer readable media. Computer readable media can be any available media that can be accessed by computer system 100 and includes both volatile and non-volatile media, removable and non-removable media. By way of example, and not limitation, computer readable media may comprise computer storage media and communication media. Computer storage media includes volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can he used to store the desired information and which can accessed by the computer system 100.

The computer system 100 further includes computer storage media in the form of volatile and/or non-volatile memory such as Read Only Memory (ROM) and Random Access memory (RAM). RAM typically contains data and/or program modules that are accessible to and/or operated on by computer processor 120. That is, RAM may include application programs, such as functional modules of the system of the present invention, and information in the form of data. The computer system 100 may also include other removable/non-removable, volatile/non-volatile computer storage and access media. For example, the computer system 100 may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system 100 to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor 120. A user may enter commands and information into the computer processor 120 through input devices such as a keyboard 101 and a pointing device 102, commonly referred to as a mouse, trackball or touch pad. Other input devices (not shown) may include a microphone, joystick, game pad, satellite dish, scanner, or the like. These and other input devices are connected to the computer processor 120 through the system bus, or other bus structures, such as a parallel port, game port or a universal serial bus (USB), but is not limited thereto. A monitor 103 or other type of display device is also connected to the computer processor 120 through the system bus or other bus arrangement. In addition to the monitor 103, the computer processor 120 may he connected to other peripheral output devices, such as printers (not shown). Commands and information may be entered by one or more users any one or more of whom may be located in the same or different locations. Commands and information may be entered at designated or random times.

The computer processor 120 may be configured and arranged to perform functions and steps embodied in computer instructions stored and accessed in any one or more of the manners described. The functions and steps, such as the functions and steps of the implementation of the relational database and its use in regard to the present invention, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor 120, instruct the computer processor 120 to perform one or more processes or acts described herein, and/or various examples, variations and combinations thereof. Such instructions may be written in any of a plurality of programming languages, for example, XML, Java, Visual Basic, C, or C++, XML, Basic, COBOL, and the like, or any of a variety of combinations thereof. Information entry may be effected using such programming languages as well as other applications including for example and in no way limited thereto, database programs ACCESS and DB2. The computer-readable medium on which such instructions are stored may reside on one or more of the components described above and may be distributed across one or mom such components.

The information and processing system of the present invention previously described with respect to FIGS. 1-9 includes a plurality of functions embodied in one or more computer programs executable through the computer processor 120 of the computer system 100, wherein signals are exchanged between the functions and the computer processor 120, and between the database 130 and the functions through the computer processor 120. All or a portion of the identified functions may be employed in carrying out steps to connect Payers and Payees in a more efficient manner than has previously been provided.

Having thus described at least one illustrative embodiment of the invention, various alterations, modifications and improvements are contemplated by the invention. Such alterations, modifications and improvements are intended to he within the scope and spirit of the invention. Accordingly, the foregoing description is by way of example only and is not intended as limiting. The invention's limit is defined only in the following claims and the equivalents thereto.

What is claimed is:

1. A method implemented, at least in part, by a computing system for secure exchange of information between payers and payees, the method comprising the steps of:
a. uploading a master payee vendor file containing vendor information to a database of an information exchange system;
b. uploading invoice status information to the database;
c. generating an invitation from a payer to a payee to join the information exchange system;
d. enabling the payer to configure prompts that the payee is required to enter to make a connection:
e. prompting the payee to enter the prompts information when they attempt to make a connection;
f. deriving a specific vendor code for the payee based upon the prompts information that the payee enters; and
g. establishing a connection between the payee and the payer in order for them to exchange private information regarding one or more business interactions between the payer and the payee.

2. The method of claim 1 wherein the vendor information uploaded to the master payee vendor file includes vendor code, vendor name, vendor address and taxpayer identification number.

3. The method of claim 1 wherein the invoice status information uploaded to the database includes a vendor code, invoice number, invoice date, invoice amount, an internal status code, a scheduled pay date, a purchase order number, and check number (if paid).

4. The method of claim 1 wherein the payer can configure the specific information which the payee will he prompted to enter when making a connection request.

5. The method of claim 1 wherein the step of generating an Invitation includes Inviting the payee to join the information exchange system by one or more of help desk recordings, check inserts, company website and e-mail.

6. The method of claim 1 wherein the step of establishing a connection between the payee and the payer includes the step of prompting the payee to enter specific information known to it and associated with the payer specific vendor code for that particular payee.

7. The method of claim 6 wherein the specific information to be entered by the payee includes one or more of a recent invoice number, a recent invoice amount, a recent invoice date, a recent check number, a recent check date, a recent purchase order number, the specific vendor code established for the payee, a Tax Payer ID number, or some combination of these fields configured by the payer.

8. A system embodied at least in part in a computing device and a database, wherein steps associated with operation of the system are embodied in one or more computer programs, for secure exchange of information between payers and payees, the system comprising:
a. a function configured to upload a master payee vendor tile containing vendor information to a database of an information exchange system;
b. a function configured to upload invoice status information to the database;
c. a function configured to generate an invitation from a payer to a payee to join the information exchange system and to configure prompts that the payee is required to enter to make a connection;
d. a function configured to prompt the payee to enter the prompts information when they attempt to make a connection;
e. a function configured to derive a specific vendor code for the payee based upon the prompts information that the payee enters; and
f. a function configured to establish a connection between the payee and the payer in order for them to exchange private information regarding one or more business interactions between the payer and the payee.

9. The system of claim 8 wherein the vendor information uploaded to the master payee vendor tile includes vendor code, vendor name, vendor address and taxpayer identification number.

10. The system of claim 8 wherein the invoice status information uploaded to the database includes a vendor code, an invoice number, the invoice date, the invoice amount, an internal status code, a scheduled pay date, a purchase order number, and a check number (if paid).

11. The system of claim 8 wherein the function configured to generate an invitation includes a sublimation configured to invite the payee to join the information exchange system by one or more of help desk recordings, check inserts, company website and e-mail.

12. The system of claim 8 wherein the function configured to establish a connection between the payee and the payer includes a subfunction configured to prompt the payee to enter specific information known to it and associated with the payer specific vendor code.

13. The system of claim 12 wherein the specific information to be entered by the payee includes one or more of a recent invoice number, a recent check number, a recent purchase order number and the specific vendor code established for the payee.

14. The system of claim 8 wherein the payer can configure the specific information that the payee is prompted to enter when making a connection request.
